(19) United States
(12) Patent Application Publication
(10) Pub. No.: US 2023/0074241 A1
(43) Pub. Date: Mar. 9, 2023

(54) ELECTRONIC DEVICE

(71) Applicant: Egis Technology Inc., Hsinchu City (TW)

(72) Inventors: Chih-Chung Tu, Hsinchu City (TW); Po-Jui Liao, Hsinchu City (TW); Yu-Min Lin, Hsinchu City (TW)

(73) Assignee: Egis Technology Inc., Hsinchu City (TW)

(21) Appl. No.: 17/799,916

(22) PCT Filed: Oct. 22, 2020
(86) PCT No.: PCT/CN2020/122774

§ 371 Date: Aug. 15, 2022

Related U.S. Application Data
(60) Provisional application No. 63/035,823, filed on Jun. 7, 2020.

(51) Int. Cl. G06V 40/13

(52) U.S. Cl. CPC G06V 40/1318; G06V 40/1324

(57) ABSTRACT

The present invention provides an electronic device including a display panel, at least one fingerprint sensing module, and at least one optical module. The display panel is adapted to provide an illumination beam to a finger to reflect a sensing beam. The fingerprint sensing module is disposed under the display panel and adapted to receive the sensing beam. The fingerprint sensing module includes a sensing area and a non-sensing area. The optical module is disposed between the display panel and the fingerprint sensing module. The optical module is adapted to transmit the sensing beam to the sensing area. The optical module has a light incidence surface, a light exit surface, and a side surface connected between the light incidence surface and the light exit surface. Both the light incidence surface and the light exit surface are non-planar surfaces, and the side surface is opaque.

### TECHNICAL FIELD

The present invention relates to an electronic device, in particular to an electronic device with a fingerprint sensing module.

### DESCRIPTION OF RELATED ART

In current ultra-thin fingerprint modules, the areas of peripheral circuit elements of photosensitive elements and border frames of traces are non-photosensitive areas. Therefore, there exists a problem that fingerprint images cannot be sensed on the surrounding border frame areas. That is, the fingerprint images that cannot be sensed will be lost, which causes the fingerprint images to be incomplete and reduces a recognition degree of the fingerprint images.

### SUMMARY

The present invention provides an electronic device, which senses fingerprint images more completely, thereby improving a recognition degree of the fingerprint images.

The present invention provides an electronic device including a display panel, at least one fingerprint sensing module, and at least one optical module. The display panel is adapted. to provide an illumination beam to a finger to reflect a sensing beam. The fingerprint sensing module is disposed under the display panel and is adapted to receive the sensing beam. The fingerprint sensing module includes a sensing area and a non-sensing area. The optical module is disposed between the display panel and the fingerprint sensing module. The optical module is adapted to transmit the sensing beam to the sensing area. The optical module has a light incidence surface, a light exit surface, and a side surface connected between the light incidence surface and the light exit surface. Both the light incidence surface and the light exit surface are non-planar surfaces, and the side surface is opaque.

Based on the above, in the electronic device of the present invention, the display panel and the fingerprint sensing module are equipped with the optical module, and the optical module is adapted to transmit the passing sensing beam to the sensing area of the fingerprint sensing module, so as to avoid transmitting the sensing beam to the non-sensing area. In this way, the sensing beam that originally falls outside the sensing area can be transmitted to the sensing area to make the fingerprint images more complete, thereby improving the recognition degree of the fingerprint images.

In order to make the above-mentioned features and advantages of the present invention more obvious and easier to understand, the following embodiments are provided and described in detail below with reference to the accompanying drawings.

### BRIEF DESCRIPTION OF THE DRAWING

FIG. 1 is a schematic cross-sectional view of an electronic device according to an embodiment of the present invention.

FIG. 2 is a schematic top view of the electronic device of FIG. 1.

FIG. 3 is a schematic perspective view of an optical module in the electronic device of FIG. 1.

FIG. 4 is a schematic cross-sectional view of an electronic device according to another embodiment of the present invention.

FIG. 5 is a schematic top view of the electronic device of FIG. 4.

FIG. 6 is a schematic top view of an electronic device according to another embodiment of the present invention.

### REFERENCE SIGNS LIST

20: Finger

100, 100A, 100B: Electronic device

110: Display panel

120: Fingerprint sensing module

122: Sensing area

124: Non-sensing area

130: Optical module

L1: Illumination beam

L2: Sensing beam

S1: Light incidence surface

S2: Light exit surface

S3: Side surface

### DESCRIPTION OF THE EMBODIMENTS

The embodiments of the present invention will be described in detail below with reference to the accompanying drawings. It is to be understood that the drawings are for purposes of description and explanation and not limitation. For clarity purposes, elements may not be shown to scale. Furthermore, some elements and/or element symbols may be omitted in some of the drawings. In the specification and drawings, same or similar element symbols are used to designate the same or similar elements. When it is stated that a component is “disposed on” or “connected to” another component, unless otherwise specified, the component may be “disposed directly on” or “connected directly to” another component, or there may be an intermediary element. It is anticipated that elements and features of an embodiment, where feasible, can be incorporated into another embodiment with benefit, and further elaboration is omitted here.

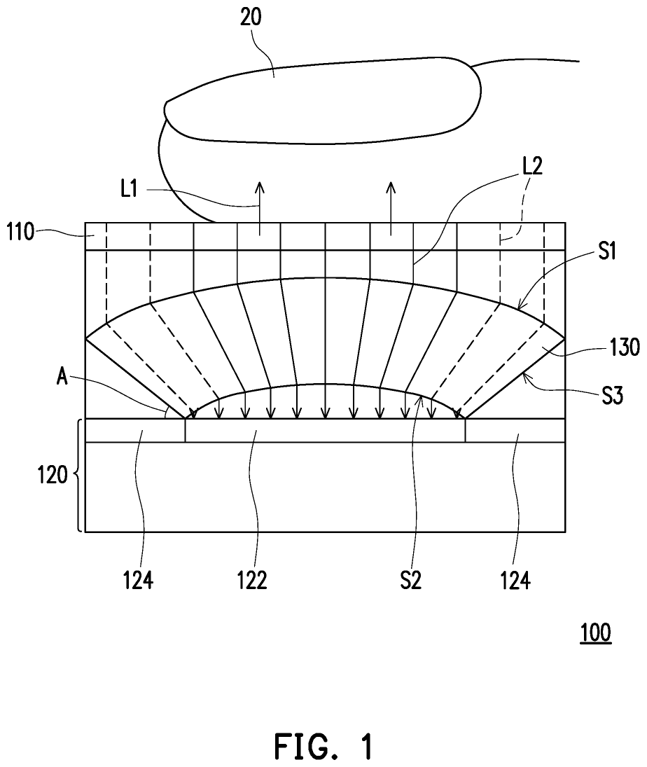

FIG. 1 is a schematic cross-sectional view of an electronic device according to an embodiment of the present invention. Please refer to FIG. 1. The embodiment provides an electronic device 100 including a display panel 110, a fingerprint sensing module 120, and an optical module 130. The display panel 110 is adapted to provide an illumination beam LI to a finger 20 to reflect a sensing beam L2. In the embodiment, the display panel 110 is, for example, an organic light-emitting diode (OLED) display panel. However, in other embodiments, the display panel 110 may also be a liquid crystal display panel or other suitable display panels, and the present invention is not limited thereto.

The fingerprint sensing module 120 is disposed under the display panel 110 and is adapted to receive the sensing beam L2 reflected by the finger 20 for fingerprint recognition. In other words, the electronic device 100 of the embodiment is an under-display fingerprint recognition device, such as a smart phone, a tablet computer, a notebook computer, or a touch-sensitive display device, and the present invention is not limited thereto. In the embodiment, the fingerprint sensing module 120 is an ultra-thin structure, with thickness of only about 300 microns, so the fingerprint sensing module 120 can be applied to the thin electronic device 100.

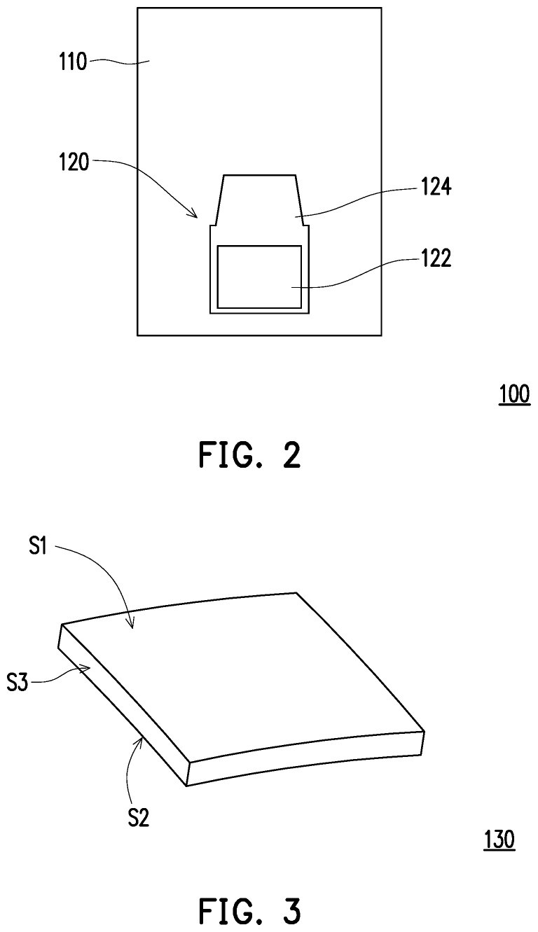

FIG. 2 is a schematic top view of the electronic device of FIG. 1. Please refer to FIG. 1 and FIG. 2 at the same time. The fingerprint sensing module 120 includes a sensing area 122 and a non-sensing area 124. In detail, the sensing area 122 is an effective photosensitive area in a sensing unit, and the non-sensing area 124 is a non-photosensitive area of the sensing unit, such as peripheral circuit structures or other areas not configured with the sensing unit.

FIG. 3 is a schematic perspective view of an optical module in the electronic device of FIG. 1. Please refer to FIG. 1 to FIG. 3 at the same time. The optical module 130 is disposed between the display panel 110 and the fingerprint sensing module 120. The optical module 130 is adapted to transmit the sensing beam L2 to the sensing area 122 of the fingerprint sensing module 120. In other words, the sensing beam L2 is not transmitted to the non-sensing area 124. Therefore, the use efficiency of the sensing beam L2 can be improved. In the embodiment, the refractive index of the optical module 130 is greater than or equal to 1.3,

Specifically, the optical module 130 has a light incidence surface S1, a light exit surface S2, and a side surface S3 connected between the light incidence surface S1 and the light exit surface S2, The light incidence surface Si and the light exit surface S2 are both non-planar surfaces, and the side surface S3 is opaque. Therefore, light can be prevented from being refracted from the side surface S3 of the optical module 130. In the embodiment, the side surface S3 and a top surface Si of the fingerprint sensing module 120 have an included angle greater than 0 degrees. In the embodiment, both the light incidence surface Si and the light exit surface S2 are aspheric surfaces, A curved shape of the aspheric surface can be described by an aspheric curved surface polynomial represented by the following formula (1), in which a center connection extension direction of two curved surfaces (i.e. the light incidence surface S1 and the light exit surface S2) is defined as a Z-axis:

z=c₀+c₂r²+c₄r⁴c₆r⁶ (1)

wherein:
z: depth of the aspheric surface in the Z-axis direction;
ci: i-th order aspheric coefficient;
r: distance from the axis.

According to the above formula (1), detailed aspheric parameters of the optical module 130 of the embodiment are as follows in Table (1):

TABLE 1

| Surface | c₀ | c₂ | c₄ | c₆ |
|---|---|---|---|---|
| S1 | 2.50013E+01 | −1.16776E−03 | −2.72968E−08 | 1.07739E−11 |
| S2 | 2.50013E+01 | −1.17243E−03 | −2.76256E−08 | 1.09911E−11 |

Through the above design, when the sensing beam L2 is transmitted into the light incidence surface S1, a first refraction occurs. When the sensing beam L2 is transmitted out of the light exit surface S2 from the inside of the optical module 130, a second refraction occurs. That is, the sensing beam L2 is refracted twice when passing through the optical module 130. Therefore, in the embodiment, a transmission path of the sensing beam L2 can be adjusted by the optical module 130, so that the sensing beam L2 located above the non-sensing area 124 of the fingerprint sensing module 120 is transmitted to the sensing area 122 by refraction. In this way, the sensing beam L2 that originally falls outside the sensing area 122 can be transmitted to the sensing area 122, thereby making fingerprint images more complete and improving a recognition degree of the fingerprint images.

In some embodiments, the electronic device 100 may further include an anti-transmission element (not shown) disposed between the optical module 130 and the non-sensing area 124 of the fingerprint sensing module 120. For instance, in an embodiment, the anti-transmission element, for example a light absorbing film, is formed on the side surface S3 of the optical module 130. In this way, the sensing beam L2 can be further prevented from scattering out from the side surface S3 of the optical module 130. In another embodiment, the anti-transmission element is, for example, a light absorbing structure made of light absorbing materials and is disposed between the side surface S3 of the optical module 130 and the non-sensing area 124 of the fingerprint sensing module 120. In this way, the sensing beam L2 can be further prevented from being transmitted from the side surface S3 of the optical module 130 to the non-sensing area 124 of the fingerprint sensing module 120.

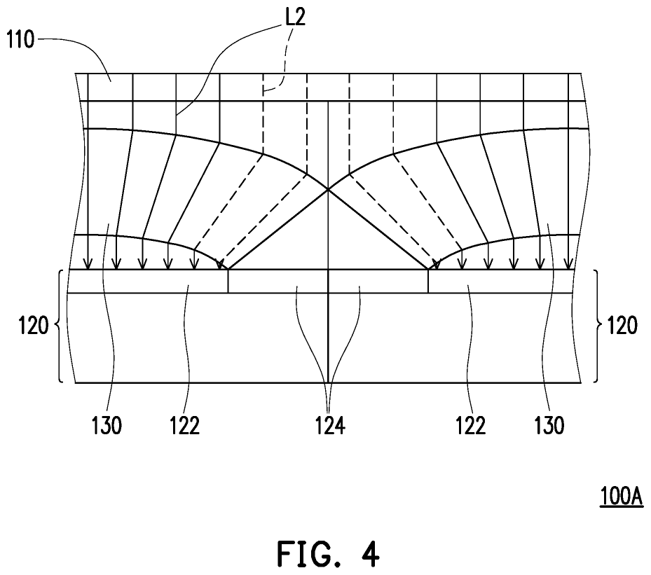

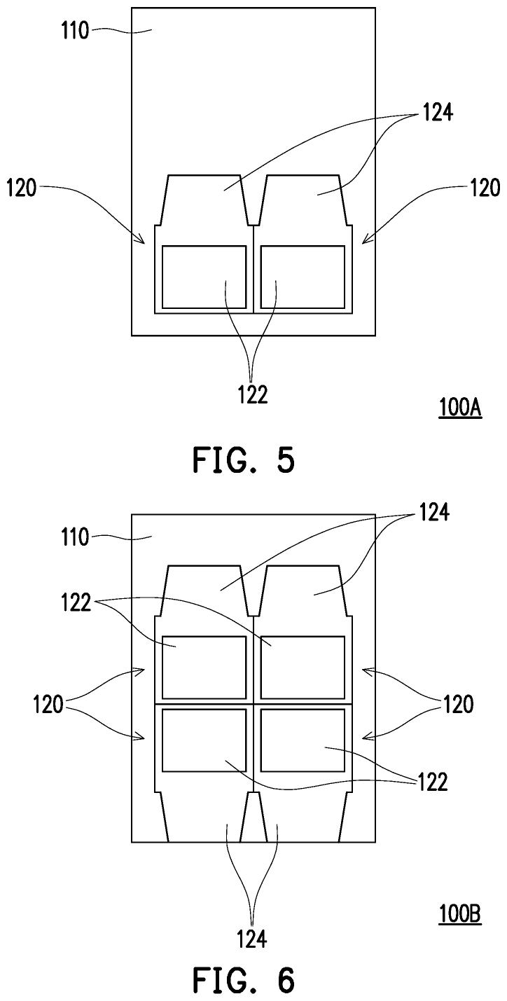

FIG. 4 is a schematic cross-sectional view of an electronic device according to another embodiment of the present invention. FIG. 5 is a schematic top view of the electronic device of FIG. 4. Please refer to FIG. 4 and FIG. 5. An electronic device 100A shown in the embodiment is similar to the electronic device 100 shown in FIG. 1 and FIG. 2. The difference between the two electronic devices is that, in the embodiment, the number of the fingerprint sensing modules 120 and the number of the optical modules 130 are both two, and the two optical modules 130 are correspondingly disposed on the two fingerprint sensing modules 120, respectively. In this way, the sensing beam L2 can be prevented from being transmitted to splices between the adjacent fingerprint sensing modules 120 in the electronic device 100A using multiple sets of the fingerprint sensing modules 120, thereby making the fingerprint images more complete, so as to improve the recognition degree of the fingerprint images.

FIG. 6 is a schematic top view of an electronic device according to another embodiment of the present invention. Please refer to FIG. 4 and FIG. 6. An electronic device 100B shown in the embodiment is similar to the electronic device 100A shown in FIG. 4, and the fingerprint sensing module 120 shown in the embodiment can be applied to the electronic device 100A shown in FIG. 4, and the present invention is not limited thereto. In the embodiment, the number of the fingerprint sensing modules 120 and the number of the optical modules 130 are both four, and the four optical modules 130 are correspondingly disposed on the four fingerprint sensing modules 120, respectively. In the embodiment, the four fingerprint sensing modules 120 are spliced in an array arrangement, but the present invention is not limited. thereto. In this way, the sensing beam L2 can be prevented from being transmitted to the splices between the adjacent fingerprint sensing modules 120 in the electronic device using multiple sets of the fingerprint sensing modules 120, thereby making the fingerprint images more complete, so as to improve the recognition degree of the fingerprint images.

In other words, in some embodiments, the number of the fingerprint sensing modules 120 and the number of the optical modules 130 may be plural and equal to each other, and the fingerprint sensing modules 120 and the optical modules 130 may be disposed corresponding to each other. Besides, a plurality of fingerprint sensing modules 120 are spliced to each other, and a plurality of optical modules 130 are also spliced to each other, and the plurality of optical modules 130 respectively correspond to the: plurality of fingerprint sensing modules 120.

To sum up, in the electronic device of the present invention, the display panel and the fingerprint sensing module are equipped with the optical module, and the optical module is adapted to transmit the passing sensing beam to the sensing area of the fingerprint sensing module, so as to avoid transmitting the sensing beam to the non-sensing area. In this way, the sensing beam that originally falls outside the sensing area can be transmitted to the sensing area to make the fingerprint images more complete, thereby improving the recognition degree of the fingerprint images.

Although the present invention has been disclosed with reference to the embodiments above, the embodiments are not intended to limit the present invention. Any person skilled in the art can make some changes and modifications without departing from the spirit and scope of the present invention. Therefore, the scope of the present invention will be defined in the appended claims.

What is claimed is:

1. An electronic device, comprising:
a display panel adapted to provide an illumination beam to a finger to reflect a sensing beam;
at least one fingerprint sensing module, disposed under the display panel and adapted to receive the sensing beam, wherein the at least one fingerprint sensing module comprises a sensing area and a non-sensing area; and
at least one optical module, disposed between the display panel and the at least one fingerprint sensing module, the at least one optical module adapted to transmit the sensing beam to the sensing area, wherein the at least one optical module has a light incidence surface, a light exit surface, and a side surface connected between the light incidence surface and the light exit surface, and the light incidence surface and the light exit surface are both non-planar surfaces, and the side surface is opaque.

2. The electronic device according to claim 1, wherein the light incidence surface and the light exit surface are both aspheric surfaces.

3. The electronic device according to claim 1, wherein an included angle greater than 0 degrees is formed between the side surface and a top surface of the at least one fingerprint sensing module,

4. The electronic device according to claim 1, wherein an orthographic projection of the light exit surface on the at least one fingerprint sensing module does not overlap with the non-sensing area.

5. The electronic device according to claim 1, wherein the sensing beam is not transmitted to the non-sensing area.

6. The electronic device according to claim 1, wherein the sensing beam is refracted twice when passing through the at least one optical module.

7. The electronic device according to claim 1, wherein further comprising an anti-transmission element disposed between the at least one optical module and the non-sensing area.

8. The electronic device according to claim 1, wherein a refractive index of the at least one optical module is greater than or equal to 1.3.

9. The electronic device according to claim 1, wherein the number of the at least one fingerprint sensing module is the same as the number of the at least one optical module, and the at least one fingerprint sensing module and the at least one optical module are disposed corresponding to each other.

10. The electronic device according to claim 1, wherein the number of the at least one fingerprint sensing module and the number of the at least one optical module are both plural, a plurality of fingerprint sensing modules are spliced to each other, and a plurality of optical modules are spliced to each other, and the plurality of optical modules respectively correspond to the plurality of fingerprint sensing modules.
